(19) United States
(12) Patent Application Publication
(10) Pub. No.: US 2005/0147956 A1
(43) Pub. Date: Jul. 7, 2005

(54) Erasable document marking apparatus

(76) Inventors: Charles Widman, Inver Grove Heights, MN (US); Tamara D. Nelson, West St. Paul, MN (US)

Correspondence Address: Altera Law Group, LLC, Suite 100, 6500 City West Parkway, Minneapolis, MN, 55344-7704, US

(21) Appl. No.: 10/752,465

(22) Filed: Jan. 6, 2004

(51) Int. Cl. B43L 1/00

(52) U.S. Cl. 434/408

(57) ABSTRACT

The present invention provides an apparatus and method for erasably marking documents. The invention provides a reusable transparent page that is removably secured to a document. The transparent page may be manufactured in a variety of standard sizes. A marker pen is provided for marking the transparent page that covers the document. The markings are easily erasable, but resistant to accidental erasure, specifically in the course of normal handling.

### FIELD OF THE INVENTION

This invention relates generally to the erasable marking of documents.

### BACKGROUND OF THE PRESENT INVENTION

In many situations it is desirable to mark certain documents for future reference while retaining the ability to maintain the document in its original, unmarked form. The types of documents for which such marking capabilities are desired vary widely. Examples of such documents include pages in books, e.g., textbooks or city map books, engineering drawings and business documents. The markings should be easily modified or erased completely, but also highly resistant to accidental erasure or modification from normal handling. A very common non-permanent document marking method involves the use of 3M Post-It® notes or the equivalent to make notes on documents. This method, however, generally requires a new Post-It® note each time a new item is to be highlighted on a document or a new document is marked.

Currently the prior art includes several disclosures of transparent sheets having information recorded thereon and which is easily removable therefrom. Each such disclosure, however, has difficulties causing it to be impracticable for use in the reusable and erasable marking of individual documents. For example, U.S. Pat. No. 5,435,601 discloses a system for a reusable fax cover letter. That invention requires securing two sheets together, one transparent and one opaque, the opaque sheet having a portion removed to form a window and the transparent sheet having preprinted information thereon. The device is restricted to sizes that are accomodatable in a normal telecopier. Because of the requirement for having two sheets, the system is relatively expensive to manufacture.

Several disclosures involve the erasable marking of labels for video cassettes, computer disks and the like. For example, U.S. Pat. No. 4,757,901 describes an erasable label kit comprising self adhesive polyester film labels, a dry-erase marking pen, an eraser having polyester pile fabric and a container for the labels, pen and eraser. The eraser required is particularly adapted for the marking pen type. As such, the eraser is prone to build-up of the marking ink eventually resulting in incomplete erasure or smearing. Additionally, the disclosure is limited to labels and does not address the problems involved with securing the transparent page to a document.

U.S. Pat. No. 5,024,332 to Stachler describes a labeling method and apparatus for identifying information on video cassettes, computer disks, containers, etc. The labels described therein are vinyl coated and the marking medium is water soluble ink and, as a result, a damp cloth is required to remove the ink.

U.S. Pat. No. 5,213,507 to Ozrovitz discloses, in part, a transparent sheet that is permanently attached and overlayed images printed on a page of a children's book, allowing the child to non-permanently mark the transparent sheet and then wipe the markings off when finished. The disclosure does not address the need for a document marking method that is adapted to be removably secured to a document and does not discuss allowing the transparent sheet to be reused in connection with different documents and documents of varying size.

Although the foregoing prior art addresses some of the various needs of the industry, the devices and methods described therein do not provide for reusable transparent sheets of varying standard sizes that are removably securable to documents and in which the identifying markings made thereon are highly resistant to smudging or smearing while allowing for easy erasing and modification.

### SUMMARY OF THE INVENTION

The present invention provides an apparatus for erasably marking documents. The invention provides a reusable transparent page that is removably secured to a document. The type and size of the document which may be used in conjunction with the invention varies widely. Pages of books such as textbooks or city map books, engineering drawings, letters, and other business-related documents are just a few examples of the variety of candidate documents. To accommodate this diversity, the transparent page may be manufactured in a variety of standard sizes. A marker pen is provided for marking the transparent page as it covers the document. The markings are easily erasable, but resistant to accidental erasure, specifically in the course of normal handling.

An object and advantage of the invention is to provide an erasable document-marking apparatus. An object and advantage of the invention is to provide an erasable document-marking apparatus in a manner such that the marking is highly resistant to accidental erasure, smudging and smearing.

Another object and advantage of the invention is to provide an erasable document-marking apparatus that is economical in cost to manufacture.

Another object and advantage of the invention is to provide an erasable document-marking apparatus which may be made in any of a standard number of sheet sizes.

Yet another object and advantage of the invention is to provide an erasable document-marking apparatus that is simple and easy to use.

Another object and advantage of the invention is to provide an erasable document-marking apparatus that reduces waste by eliminating the need for paper document-marking methods.

The foregoing objects and advantages of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 is a perspective view of the erasable document-marking apparatus secured to pages of a book.

FIG. 2 is a front view of the erasable document-marking apparatus.

FIG. 2 is a side view of the erasable document-marking apparatus.

### DETAILED DESCRIPTION OF THE INVENTION

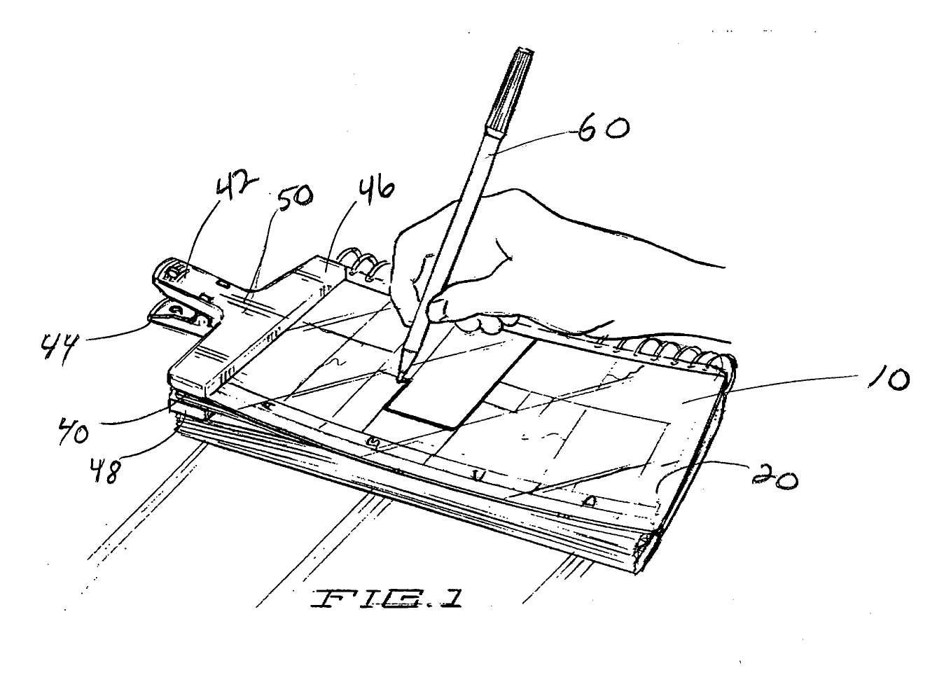

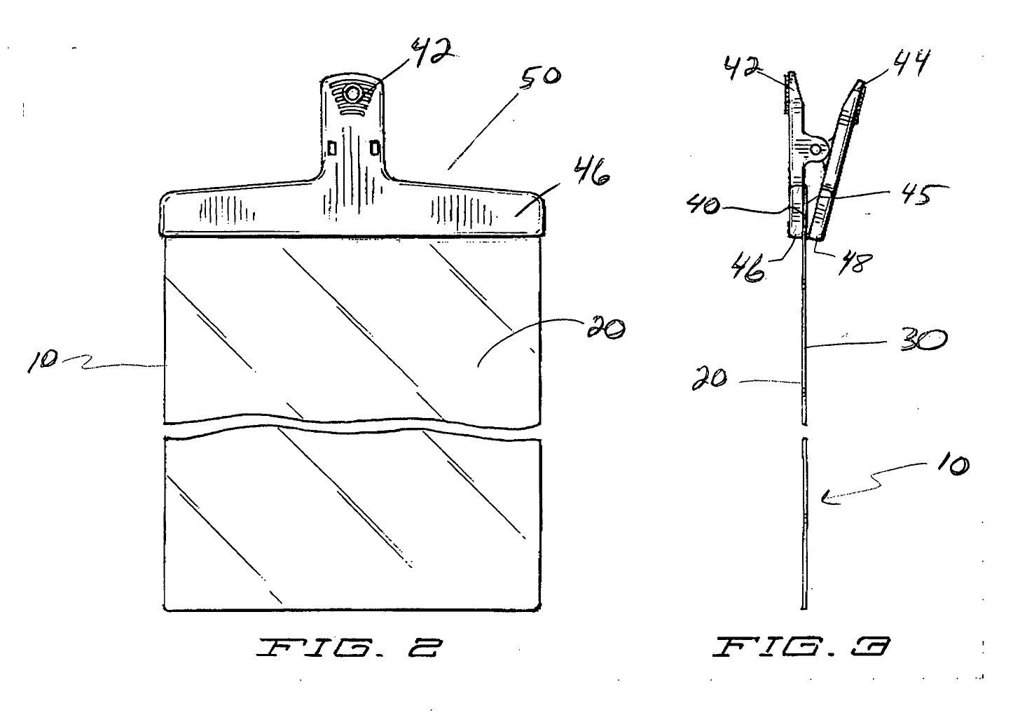

With reference to the accompanying figures, there is provided an apparatus for the reusable erasable marking of documents. FIGS. 1-3 illustrate one embodiment of the device. A transparent sheet 10 is laid upon the document of interest, in the illustrated case a page in a spiral-bound book. The transparent sheet 10 is removably secured to the document with the first side 20 of the transparent sheet being exposed and available for marking and the second side 30 of the transparent sheet being disposed adjacent to and overlaying the document of interest as seen in FIG. 3.

As best illustrated in FIG. 3, the top edge of the transparent sheet first side 40 is secured to a clamp 50 in one embodiment. The clamp 50 is then used to secure the transparent sheet 10 to the document of interest, with the second side 30 adjacent to and overlaying the document and with the first side 20 exposed for marking. The marking pen 60 is then used to erasably mark the transparent sheet front side 20. An eraser, not shown in the figures, may be used to remove the markings either partially or completely. The eraser may be a dry or damp cloth or any other similar means that will allow for the wiping removal of the markings.

As seen in the Figures, a clamp 50 to removably secure the transparent sheet to the document of interest is provided. In this embodiment, the clamp 50 is secured to the top edge of the transparent sheet first side 40 by an adhesive or the equivalent. The upper 46 and lower 48 clamp jaws are opened by applying pressure to the upper 42 and lower 44 handles, the document of interest inserted between the upper 46 and lower 48 jaws and the document secured by closing the clamp jaws on the document. Other methods to removably secure the transparent sheet to a document include applying an adhesive strip to the top edge of the transparent sheet second side 45, thus allowing the transparent sheet 10 to be removably secured to the document of interest by placing the transparent sheet 10 on the document and applying pressure to the top edge of the transparent sheet first side 40.

The transparent sheet 10 may in one embodiment be composed of a non-top coated polyester film. In this case, the preferred marking pen 60 may be of the dry erase variety to maximize smudge and smear resistance while allowing for ease of erasure. In another embodiment, the transparent sheet 10 may be composed of vinyl. In this embodiment, the marking pen 60 may contain a water soluble ink to accomplish the goals described herein.

In another embodiment, not shown in the Figures, the transparent sheet may be placed over a game card, for example the Yahtzee® game score card. This allows the cardboard score card to be reused. The transparent sheet may, in this embodiment, be clamped to the game card or, alternatively, may be configured to form a pocket into which the game card may be dropped. Other equivalent applications readily present themselves to those skilled in the art.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. An apparatus for erasably marking a document, comprising:
a reusable transparent sheet comprising non-top coated polyester film, the sheet having a first side and a second side, a top edge on the first side and a top edge on the second side;
a clamping device for securing the sheet to the document, the top edge of the first side of the sheet further comprising an adhesive coating wherein the clamping device is removably adhered to the sheet; and
a dry erase marking pen for marking the first side of the sheet.

2. (canceled)

3. The apparatus of claim 1, further comprising an eraser for erasing the markings.

4. An apparatus for erasably marking a document, comprising:
a reusable transparent sheet comprising vinyl, the sheet having a first side and a second side, a top edge on the first side and a top edge on the second side;
a clamping device for securing the sheet to the document, the top edge of the first side of the sheet further comprising an adhesive coating wherein the clamping device is removably adhered to the sheet; and
a marking pen containing water soluble ink for marking the first side of the sheet.

5. (canceled)

6. The apparatus of claim 4, further comprising an eraser for erasing the markings.

7. (canceled)

8. (canceled)

9. (canceled)

10. (canceled)

11. An apparatus for erasably marking a document, comprising:
a reusable transparent sheet composed of non-top coated polyester film, the sheet having a first side and a second side, a top edge on the first side and a top edge on the second side;
a clamping device for securing the sheet to the document, the top edge of the first side of the sheet further comprising an adhesive coating wherein the clamping device is removably adhered to the sheet;
a dry erase marking pen for marking the first side of the sheet; and
an eraser for erasing the markings.

12. An apparatus for erasably marking a document, comprising:
a reusable transparent sheet composed of vinyl, the sheet having a first side and a second side, a top edge on the first side and a top edge on the second side;
a clamping device for securing the sheet to the document, the top edge of the first side of the sheet further comprising an adhesive coating wherein the clamping device is removably adhered to the sheet;
a marking pen with water soluble ink for marking the first side of the sheet; and
an eraser for erasing the markings.

13. (canceled)

14. (canceled)
